(19) United States
(12) Patent Application Publication
(10) Pub. No.: US 2023/0093609 A1
(43) Pub. Date: Mar. 23, 2023

(54) MULTIFUNCTION LIGHT VEHICLE CHARGING PLATFORM

(71) Applicant: Swiftmile, Inc., San Carlos, CA (US)

(72) Inventors: Keith Edward Moravick, Mountain View, CA (US); Ken Wolz, Fairfax, CA (US); Bradlee Van Pelt, Santa Ynez, CA (US); Leandro Vera, Hayden, ID (US); Jay Parekh, Redwood City, CA (US); Douglas Ralph Schaller, San Carlos, CA (US)

(21) Appl. No.: 17/482,465

(22) Filed: Sep. 23, 2021

(51) Int. Cl. B60L 53/30; B60L 53/51; B60L 53/53; B60L 53/67; B60L 53/66

(52) U.S. Cl. CPC B60L 53/305; B60L 53/51; B60L 53/53; B60L 53/66; B60L 53/67; B60L 2200/12; B60L 2250/16; B60L 2250/20; B60L 2250/22

(57) ABSTRACT

A multifunction electric vehicle charging platform is provided. The platform includes a housing and at least one display unit placed in the housing. The platform further includes a content management unit configured to control receiving content and display the content on the at least one display unit. The platform includes a charging unit configured to be connected to at least one light electric vehicle (LEV) and to provide power to the at least one LEV. The platform includes at least one sensor attached to the housing and configured to collect data associated with the at least one LEV. The platform further includes a communication unit configured to communicate with a backend system.

### TECHNICAL FIELD

The present disclosure relates generally to electric vehicles such as light electric vehicles (LEV) or battery electric vehicles (either can be referred to as a LEV), charging structures for the LEVs and, specifically, to a multifunction electric vehicle charging platform.

### BACKGROUND

There are two basic categories of LEVs in use today: shared fleet vehicles and privately owned vehicles. Maintaining an effective and efficient LEV ecosystem requires regular recharging of the vehicle batteries to keep them operational regardless of whether they are shared fleet vehicles or privately owned. The charge infrastructure must be sustainable in all environments including urban, suburban, or rural settings. Sustainability has many facets including economic sustainability, ecological sustainability, and a resilience to common wear and tear on the hardware itself.

Conventional means of re-charging LEVs require human intervention and economic subsidies. Specifically, conventional LEV charging systems require a significant financial investment without a direct means of recouping the cost of the hardware and, therefore, fail to be economically sustainable. Additionally, conventional LEV charging systems occupy more space that is available in urban settings.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to one approach of the present disclosure, a multifunction electric vehicle charging platform is provided. The platform may include a housing and at least one display unit placed in the housing. The platform may further include a content management unit configured to control receiving content and displaying the content on the at least one display unit. The platform may include a charging unit configured to be connected to at least one LEV and to provide power to the at least one LEV. The platform may include at least one sensor attached to the housing and configured to collect data associated with the at least one LEV. The platform may further include a communication unit configured to communicate with a backend system.

According to another approach of the present disclosure, a multifunction electric vehicle charging platform is provided. The platform may include a housing and at least one display unit placed in the housing. The platform may further include a content management unit configured to control receiving content and displaying the content on the at least one display unit. The platform may include a charging unit. The charging unit may include a charge-head board, a power distribution board, and a charge cable. The charge-head board and the power distribution board may be installed in the housing. The platform may further include at least one sensor attached to the housing and configured to collect data associated with an at least one LEV. The platform may include a communication unit configured to communicate with a backend system. The platform may further include a plurality of docking and charging bays for docking the at least one LEV. The plurality of docking and charging bays may be installed at a predetermined distance from the housing. The charge cable may connect the charge-head board and each of the plurality of docking and charging bays. The charge cable may be configured to supply power from the charging unit to the at least one LEV when the at least one LEV is docked in one of the plurality of docking and charging bays.

Additional objects, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF THE DRAWINGS

The features of the invention are set forth with particularity in the appended claims. A better understanding of the features and advantages of the present invention will be obtained by reference to the following detailed description that sets forth illustrative embodiments, in which the principles of the invention are utilized, and which the accompanying drawings illustrate.

FIG. 1 is an exploded front view of a multifunction electric vehicle charging platform, according to an example embodiment.

FIG. 2 is an exploded right side view of a multifunction electric vehicle charging platform, according to an example embodiment.

FIG. 3 is a front view of a multifunction electric vehicle charging platform, according to an example embodiment.

FIG. 4 is an exploded front view of a multifunction electric vehicle charging platform, according to an example embodiment.

FIG. 5 is an exploded rear view of a multifunction electric vehicle charging platform, according to an example embodiment.

FIG. 6 is a front view of a housing enclosing components of a multifunction electric vehicle charging platform, according to an example embodiment.

FIG. 7 is a block diagram illustrating components of a multifunction electric vehicle charging platform, according to an example embodiment.

FIG. 8 is a front view of a multifunction electric vehicle charging platform, according to an example embodiment.

FIG. 9 is a rear view of a multifunction electric vehicle charging platform, according to an example embodiment.

FIG. 10 is a top view of a multifunction electric vehicle charging platform, according to an example embodiment.

FIG. 11 is a front perspective view of a multifunction electric vehicle charging platform, according to an example embodiment.

FIG. 12 is a front perspective view of a multifunction electric vehicle charging platform, according to an example embodiment.

FIG. 13 is a rear perspective view of a multifunction electric vehicle charging platform, according to an example embodiment.

FIG. 14 is a front view of a docking and charging bay, according to an example embodiment.

FIG. 15 is a front perspective view of a docking and charging bay, according to an example embodiment.

FIG. 16 is a front view of a docking and charging bay, according to an example embodiment.

FIG. 17 is a front perspective view of a docking and charging bay, according to an example embodiment.

FIG. 18 is a portion view of a docking and charging bay, according to an example embodiment.

FIG. 19 is a computing system that can be used to implement a multifunction electric vehicle charging platform, according to an example embodiment.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The present disclosure provides a multifunction electric vehicle charging platform and, more specifically, an autonomous and connected multifunction smart electric vehicle charging platform containing a plurality of sensors and displays for use in all environments and locations. The multifunction electric vehicle charging platform (also referred to as “platform”) may have a housing and one or more display units installed in the housing. The housing may have a shape of a rectangular parallelepiped having a first side and a second side opposite to the first side. If the platform has two display units, one of display units may be placed on the first side of the housing and the other of display units may be placed on the second side of the housing such that the display units face opposite directions.

The platform may further include a content management unit configured to control receiving content and displaying the content on the at least one display unit. The content may be selected based on data collected (e.g., via sensors) by the platform. The collected data may include demographics, a number of people, a face, a gender, an age, shops or facilities in proximity to the platform, and so forth. In an example embodiment, the content may be selected to fit interests of a broad audience that can be detected in proximity to the platform. In some embodiments, the collected data are provided to content providers so that the content providers can select the content to be displayed by the platform. In an example embodiment, the collected data may be analyzed in real time and the content displayed by the platform can be changed in real time too.

In an example embodiment, the platform can be in communication with a programmatic advertisement network and can enable marketers and advertisers from anywhere around the world to bid on a displaying time and advertisements to be displayed by the platform. In other words, the platform may communicate with a third party advertisement market.

The platform may further have a charging unit, at least one sensor, and a communication unit. The charging unit may be configured to be connected to at least one LEV and provide power to the at least one LEV. The at least one sensor may be attached to the housing and may be configured to collect data associated with the at least one LEV. The communication unit may be configured to communicate with a backend system.

The platform can be located anywhere where there is adequate power available. Through its modular construction, the platform can be configured to be cost effective to operate as minimally impactful to the environment and be robust to weatherization, vandalism, and extensive use through its remote connectivity and array of sensors.

The components and sensors available in the platform of the present disclosure are necessary to achieve full sustainability of the platform. Additionally, the combination of all of the features of the platform provides a previously unavailable compact form that enables placement of the charging platform in locations where it was not feasible before.

Furthermore, the inclusion of displays and a content management unit in the platform provides for additional functionality that has been proven to generate significant revenues The revenue generating features as well as many of the onboard sensors along with the smart charging and multimodal docking ability make the platform of the present disclosure unique.

The platform ties together charging technologies and adds the monetization capabilities of advertising and advertisement networks to eliminate the mostly costly aspects of providing LEV charging infrastructure. With the inclusion of the multi-configurable, multifunction charging station, infrastructure providers do not need to haphazardly integrate disparate systems to provide a holistic solution. The platform seamlessly integrates all of the systems in one package to address the needs of the shared fleet vehicle operators and private vehicle owners alike. It removes the needs for third party integrators and enables operating and monitoring of remotely placed stations in any setting and in any environment. The inclusion of sensors improves the ability to resolve previously unknown states such as parking without charging and also provides feedback on the effectiveness of an advertisement being displayed.

In general, the platform packs all of the ability of a smart charging station and display units (which act as advertising units) into a single enclosure. The integrated platform offers a vehicle charging operator the option to display advertisements, instructions, public service announcements, branding information, real time data streams that may contain various information, such as transit information for public transport, a state of charge information, parking availability in the attached station or stations at other locations, and so forth. The inclusion of parking sensors in each docking and charging bay enables the platform to report the total number of available bays and occupied bays by LEVs that are simply using the docking and charging bay to park. This information can be relayed to a backend system where the information can be then broadcast and made available to a subscriber of the data stream via webhooks or application programming interfaces (APIs).

In an example embodiment, LEVs can park and recharge their batteries. When a charge cable is plugged in, or when a cable-free charge adapter is inserted into the platform, a LEV is detected through the use of a charge detection algorithm by way of the charge cable. Upon electrical detection of a connected battery, the smart charging electronics of the platform determine what voltage and current the LEV is able to accept.

It should be noted that cable free charging could be accomplished via inductive charging mechanisms, including electromagnetic induction, magnetic resonance, electric field coupling, etc.

After this determination is made either by algorithm or bi-direction communications with an installed vehicle communication board, charge power is applied. In an example embodiment, the LEV may remain connected to the platform until the battery is completely charged. At this point, many vehicle types behave differently depending on their respective battery management systems (BMSs). Some BMSs instruct the battery and LEV to turn off (disconnect electrically). In conventional charging systems, there is no way to know if the LEV has been removed from the docking and charging bay unless information from the parking sensor is available. If the parking sensor information is used in conjunction with the charge cable or charge adapter, the state of any docking and charging bay can always be known in full and no errors in bay availability may be made. If, however, a parking sensor is not installed on the docking and charging bay, as implemented in some conventional charging systems, there is a chance that a user would remove a LEV, and the charging system would not be aware of this and would keep the docking and charging bay marked as occupied when there is in fact no LEV present because the LEV was removed when no power was being delivered. In the same way, a LEV equipped with a vehicle communication board (VCB) can tell the platform when a LEV is present and connected even if no power is being drawn by the battery. If the platform received its charge instruction from the VCB rather than the detection algorithm, there can be positive confirmation that the LEV is still present as long as the VCB is still connected electrically to the platform. All of these devices working in conjunction resolve all unknown states that previously may have existed.

The multifunction electric vehicle charging platform has another benefit of reducing the footprint of a charging station. All of the charge electronics and sensor controllers can be housed in the same housing that is used for the display unit and the content management unit. This saves space and increases the flexibility for installations. The multifunction electric vehicle charging platform also provides the flexibility to configure charging ports or charging bays. Additionally, the platform can be operated as a parking and advertisement unit system without the charge electronics providing a vehicle charging operator with a simplified system using less power.

Once all charge electronics are packaged inside the housing, the charge connection with the LEV can be configured in any number of ways. For example, a conduit can be installed along the wall and individual charge cables can be brought out from the conduit so that users can park the LEVS against the wall. This allows charging the LEV without a separate electronics enclosure. This also allows decoupling a place where the actual LEV is parked and a place where the charge electronics and display units are accommodated. Therefore, charging of the LEV is not tied to a fixed location because the charge cables can be run from the platform along a wall or ground to any place where the parking is possible. The charge cables may be connected to the platform by one end and may have a plug on the other end. To charge the LEV, the user may connect the plug to the LEV. The charge cables may be laid (e.g., in a conduit either on the ground or on the wall) any distance away from the housing of the platform. Therefore, the charging at the platform is not tied to a fixed form factor of a dedicated charging and parking bay.

The platform may be installed in public places or in private locations. In some embodiments, the platform may display advertisements and users of the platform may not be charged for using the platform to charge the LEV. Providers of the platform may receive the revenue from content providers that provide advertisements or other content to be displayed by the platform. In other embodiments, the users may pay for the electricity but may not be charged for using the platform itself. In some embodiments, revenue sharing models may be used to share the revenues obtained for displaying advertisements with any of city authorities, electricity providers, gas station owners, airport parking owners, and so forth.

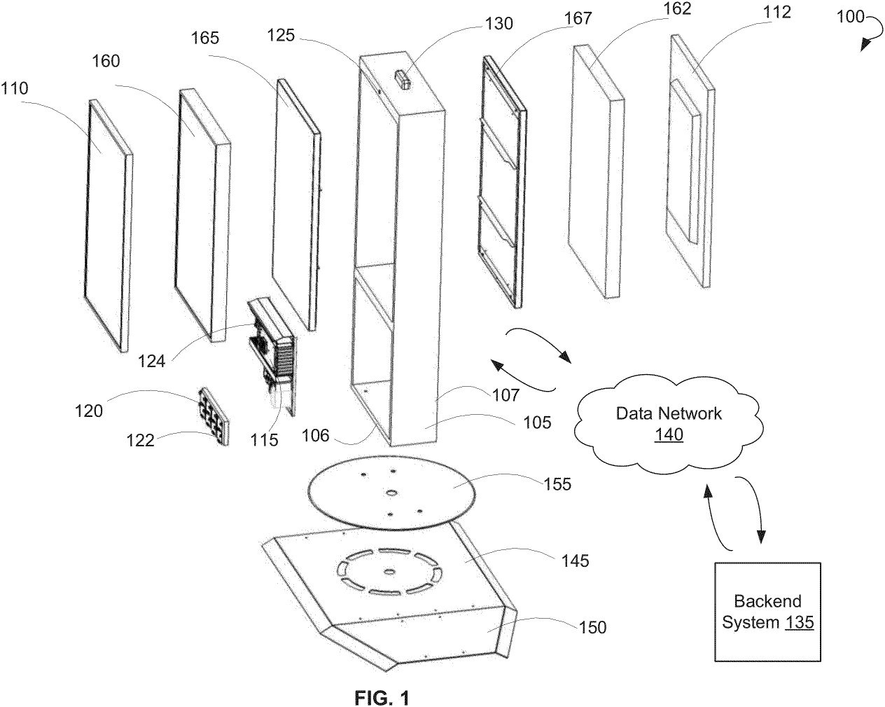

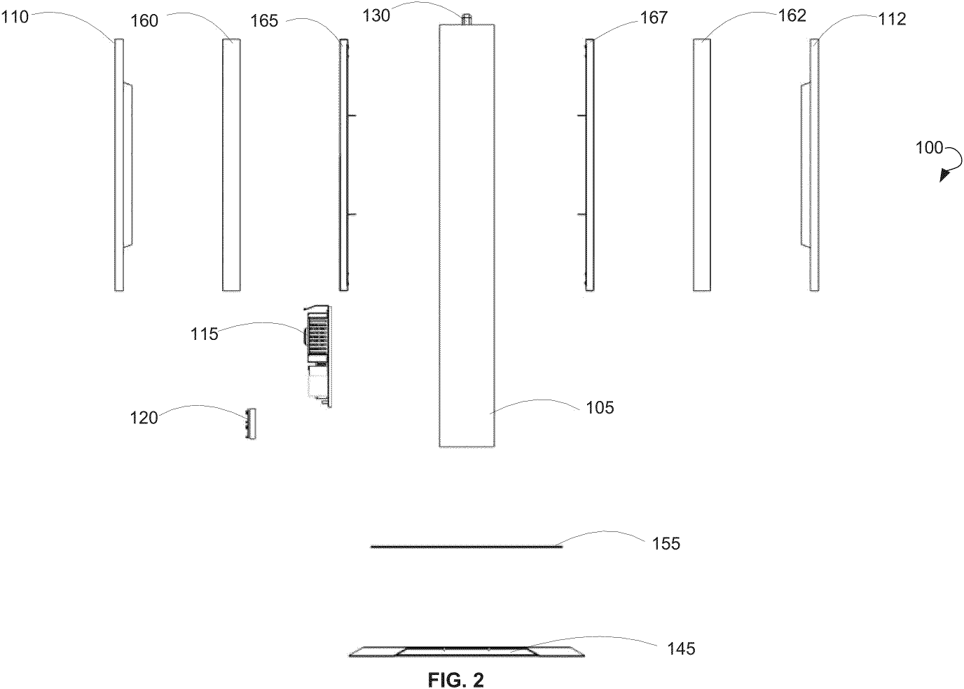

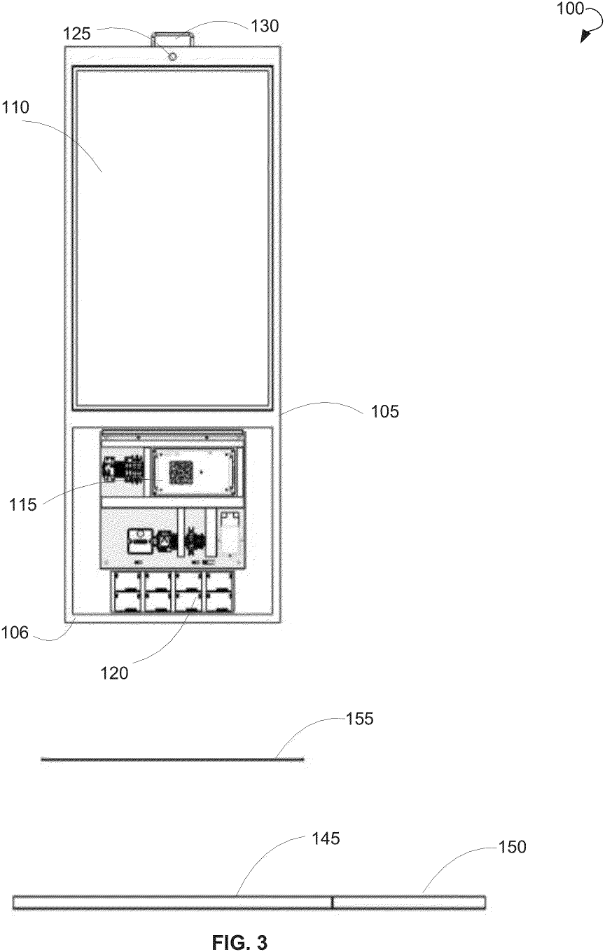

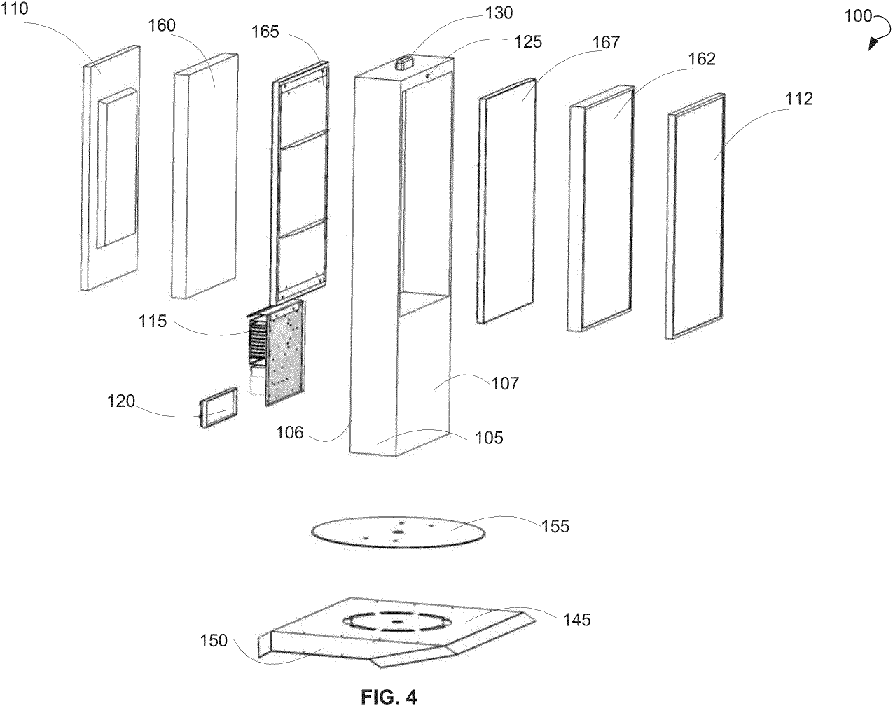

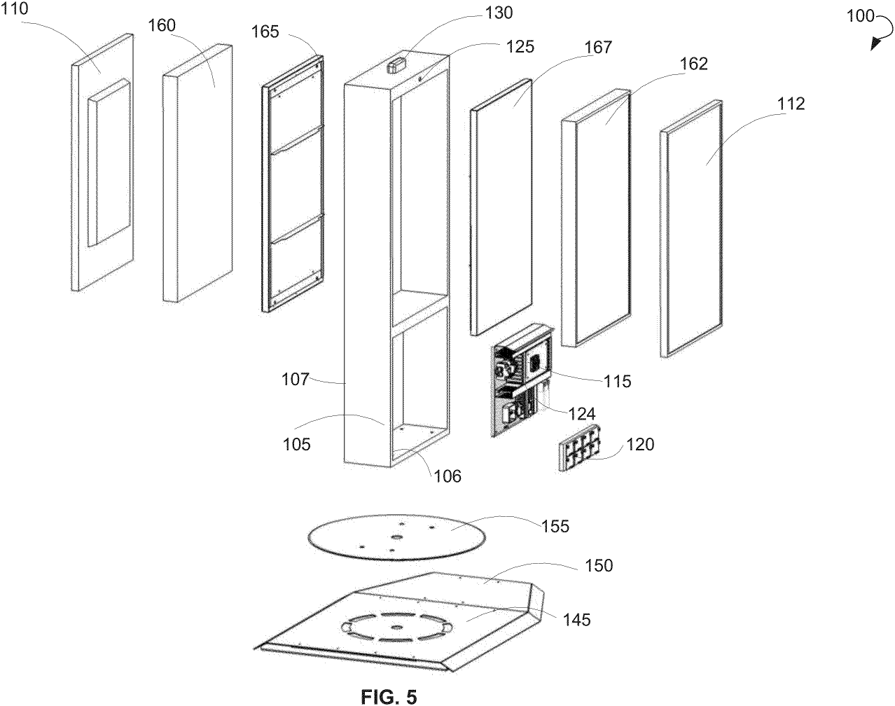

Referring now to the drawings, FIGS. 1-5 are views of a multifunction electric vehicle charging platform 100 (also referred to herein as a platform 100) from various perspectives, according to an example embodiment. Specifically, FIG. 1 is an exploded front view of the platform 100, FIG. 2 is an exploded right side view of the platform 100, FIG. 3 is a front view of the platform 100, FIG. 4 is an exploded front view of the platform 100, and FIG. 5 is an exploded rear view of the platform 100.

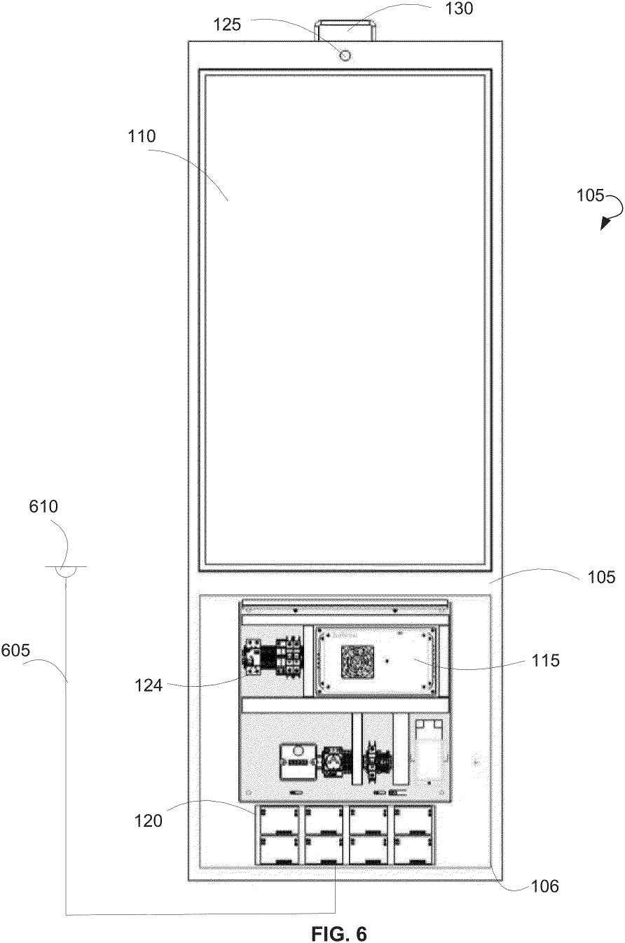

The platform 100 may include a housing 105, at least one display unit 110 and/or 112 placed in the housing 105, a content management unit 115, a charging unit 120, at least one sensor 125, and a communication unit 130. FIG. 6 is a front view of the housing 105 enclosing components of the platform 100, according to an example embodiment.

In an example embodiment, the housing 105 may be implemented in form of a free standing multifunction double sided cabinet. The housing 105 may have any of steel, stainless steel, aluminum, or any other construction. The housing 105 may further have welded seams and screws seams connecting parts of the housing 105. In other example embodiments, the housing 105 may be in form of a wall mounted multifunction housing or a hanging multifunction housing.

In an example embodiment, the housing 105 may have a shape of a rectangular parallelepiped having a first side 106 and a second side 107 opposite to the first side 106. A first display unit 110 may be placed on the first side 106 and a second display unit 112 may be placed on the second side 107. The first display unit 110 and the second display unit 112 may face opposite directions.

In an example embodiment, the platform 100 may have one or more static advertisement displays, for example, a static advertisement display 160 on the first side 106 of the housing 105 and static advertisement display 162 on the second side 107 of the housing 105. The static advertisement display 160 may be a backlit unit and the platform 100 may have light emitting diode (LED) or other backlight drivers to illuminate the static advertisement display 162. The display 160 may further be simply a painted or printed image. The display 160 may also be wrapped, may not utilize back lighting, and may not be controlled by the content management system.

The platform 100 may have optical light diffusers for the static advertisement display 160. The platform 100 may further have sensors for controlling backlight brightness. In a further example embodiment, the platform 100 may have one or more television (TV) blanks, for example, a blank panel 165 on the first side 106 of the housing 105 and a TV blank 167 on the second side 107 of the housing 105.

In an example embodiment, the platform 100 may have at least one of the display unit 110 or 112, the static advertisement display 160 or 162, and the blank panel (TV) 165 or 167, or any combination of the display unit, the static advertisement display, and the blank panel.

The housing 105 may have removable panels for mounting components inside the housing 105. The housing 105 may further have hinged panels for access and installing double sided displays 110 and 112. The housing 105 may further have door and panel locks to lock the panels and doors of the housing 105.

The platform 100 may further have a baseplate 145. The baseplate 145 may have one or more spacers 150. The platform 100 may further have a rotatable disk 155 placed on the baseplate 145. The housing 105 may be installed on the rotatable disk 155. The rotatable disk 155 may be configured to perform 360 degrees of rotation around a vertical axis. When rotating, the rotatable disk 155 may rotate the housing 105 installed on the rotatable disk 155.

The platform 100 may further have an anchor plate with a leveling feature for mounting the housing 105 and leveling the housing 105 horizontally. The platform 100 may further have a leveling anchor plate skirt and a baseplate cover for concealing the anchor plate. The platform 100 may be bolted to the ground, e.g., by screwing anchor bolts into the concrete.

The content management unit 115 may be configured to control receiving content and displaying the content on the at least one display unit 110. In an example embodiment, the content management unit 115 may include one or more processors. The content may include one or more of the following: an advertisement, transportation station transit information, a notification, a public service announcement, a warning, a transport schedule, a number of available docking and charging bays, and so forth. The content may be received from the backend system 135. The content may be selected based on data collected (e.g., via sensors) by the platform 100. The collected data may include demographics, a number of people, a face, a gender, an age, shops or facilities in proximity to the platform, and so forth. In various embodiments, sensors may be used to monitor air temperature, barometric pressure, brightness/darkness, air quality (including pollutants and gases such as CO₂ and CO), sound/noise, images, wind speed, and wind chill. Sensors may further include capacitance sensors for sensing contact with the unit, accelerometers for sensing movement of the unit or inclination due to being hit or pushed over, or the accelerometers may be use to confirm earthquakes.

In some embodiments, the collected data can be provided to content providers so that the content providers can select the content to be displayed by the platform.

In an example embodiment, the collected data may be analyzed in real time. The content management unit 115 may be configured to change the content displayed on the at least one display unit in real time. The content to be displayed may be selected based on the analyzed data associated with the at least one LEV and data related to an environment where the platform 100 is disposed. In an example embodiment, the content may be selected to fit interests of a broad audience that can be detected in proximity to the platform. The display can also be used to show the state of charge of the LEV, date and time, etc.

The charging unit 120 may be configured to connect to at least one LEV and to provide power to the at least one LEV. The charging unit 120 may include a charge headboard 122 and a power distribution board 124. Charge electronics of the platform 100 may further include a controller board for controlling the charging. The charge headboard 122 and the power distribution board 124 may be installed in the housing 105. In an example embodiment, the charge headboard 122 may further include lock sensors, lock drivers, and LED drivers. The charge headboard 122 may further have a charge head. The charge head may have multiple contacts for receiving an external connector interface of the LEV. Therefore, the external connector interface of the LEV may be connected directly to the charge head placed in the housing 105. The charging unit 120 may be configured to connect to one or more power sources (not shown). The one or more power sources may be selected from an electric grid, a solar power source, a self-generating power source, a storage battery, a backup battery, and any other power source. In an example embodiment, the power source may include an AC-DC power supply. The platform 100 may further include a solar charge controller for controlling solar power charging of the LEV. The platform 100 may further include an AC battery charger for controlling charging the battery of the LEV by the AC current. The platform 100 may also have one or more baseplates for accommodating the charging unit 120. The charging unit 120 may have further charge adapters for charging multiple type of the LEVs.

The power source may include solar panels associated with the platform 100. The power generated by the solar panels may be used for charging the LEVs, providing the power to the parking sensor, providing the power to the one or more display units, providing the power for a cellular radio connection, and providing the power to other components of the LEV or platform 100.

The charging unit 120 may be configured to read one or more parameters associated with the at least one LEV. The one or more parameters may include a charge level of the at least one LEV, a charge state of the at least one LEV, a rate of charge, a voltage, a current, a type of the battery, time, and so forth.

The at least one sensor 125 may be an image sensor, such as a camera. The sensor 125 may have sensor lenses, a sensor housing, a sensor driver, and cables. The sensor 125 may be attached to the housing 105 and may be configured to collect data associated with the at least one LEV. The data collected by the at least one sensor 125 may include one or more of the following: a number of people walking in a proximity of the platform, demographics associated with the people in the proximity of the platform, a face of a person, a gender of the person, an age of the person, and so forth. In an example embodiment, the data associated with the LEV may include charge information, battery requirements, a battery state, pre-use settings, an identifier (ID) of the at least one LEV, a state of the battery, temperature of the battery, vehicle circulation, infrastructure utilization, and so forth.

The communication unit 130 may be configured to communicate with a backend system 135 via a data network 140. The data network 140 can refer to any wired, wireless, or optical networks including, for example, the Internet, intranet, local area network, Personal Area Network, Wide Area Network, Virtual Private Network, cellular phone networks (e.g., Global System for Mobile communications network), Wi-Fi™ network, packet switching communications network, circuit switching communications network), Bluetooth™ radio, Ethernet network, an IEEE 802.11-based radio frequency network, a Frame Relay network, Internet Protocol (IP) communications network, or any other data communication network utilizing physical layers, link layer capability, or network layer to carry data packets, or any combinations of the above-listed data networks. In some embodiments, the data network 140 includes a corporate network, data center network, service provider network, mobile operator network, or any combinations thereof.

The platform 100 may further include a parking sensor. The parking sensor may be configured to detect one or more of the following: presence of the at least one LEV connected to the charging unit, a total number of available bays, a total number of occupied bays for docking, a total number of occupied bays for docking and charging, and so forth.

In an example embodiment, the housing 105 may have a waterproof internal cabinet for housing electronic systems. The electronic systems may include cable glands to maintain watertight pass-through, an electrical junction box for incoming power, a climate controller with heaters, a heat exchanger, and the power distribution board.

In an example embodiment, the platform 100 may further have temperature sensors placed inside the housing 105, intake fans, output fans, air vent ducts, perforated panels for in/out air, and separator baffles to control the environmental conditions inside the housing 105 and avoid overheating of the components of the platform 100.

In an example embodiment, all components of the platform 100 may be installed and secured in a theft-resistant way to prevent unauthorized users from detaching the components of the platform 100 from the housing 105 and accessing the components inside the housing 105.

In an example embodiment, communication between the platform and the LEV and control of the LEV may be performed over a power line. Specifically, direct data communications between LEVs and the platform may be established over a charging power line. The direct communications can include two-way communications or one way communications. When the LEV is plugged into the platform, a charging structure of the LEV receives power and is able to deliver information concerning the LEV to the platform. For example, the information can include an ID of the LEV. Any information received from the LEV can be associated with the LEV based on the ID. For example, the associated information can include a state of the battery of the LEV, such as a temperature of the battery. The temperature of the battery can affect charging capabilities and charging procedures and protocols. At low temperature, a lithium ion battery needs to be charged differently than at higher temperatures. In some embodiments, based on the provided information, a heater of the LEV can be activated to bring the battery of the LEV up to an appropriate temperature for charging.

The information can be exchanged using a charge interface over a wired connection, such as a two-wire connection, that is used to deliver power to the LEV. The charging structure of the LEV can include charge electronics and a vehicle interface board. The vehicle interface board can include a microprocessor or a microcontroller. The vehicle interface board can be integrated into a LEV. The communications between the platform and the charging structure of the LEV can be carried out at the charger level. The charging unit of the platform can be connected to the charging structure of the LEV via a Controller Area Network (CAN) bus.

Because there are many different battery standards, it is important for the power structure (i.e., the platform) to have vehicle battery information in order to safely connect to the LEV and charge the vehicle battery properly without causing any issues to the LEV or the platform. In an example embodiment, a data coupler in the LEV can be used to superimpose the communication signal over the power line. There can be different types of data couplers and several methods that can be used to superimpose the data signal on the power signal. For example, the power delivered by the platform to the LEV can be DC power or AC power such that the ground voltage is around zero and the high voltage is around 42 volts. As the vehicle battery discharges, the voltage of the vehicle battery drops. The data communication channel can be coupled onto the power line by small voltage modulation on top of the standard voltage provided to the LEV. The signal can be coupled and decoupled by the system and charging structure on both the transmitting and receiving ends and, thus, transmitted over the power line. Therefore, the power line can be used both to communicate a power signal to provide power from the platform to the battery of the LEV and to bidirectionally communicate a data signal to exchange, in the data signal, data between the LEV and the platform.

The platform provides sustainability, safety, and cost savings. The sustainability in the ecosystem is achieved by providing an infrastructure of charging stations to support all types of LEVs. The safety is provided due to the information exchange such that it is known that the LEV is safely charged under the conditions. The cost savings can be achieved because, among other reasons, there is no need to have an operation crew to pick up LEVs and bring them home to charge.

As shown in FIG. 6, the platform 100 may include a charge cable 605 and a plug 610. The charge cable 605 can have any predetermined length and can be laid along a wall or ground. Therefore, the plug 610 to be inserted into the LEV for charging can be located distantly from the housing of the platform 100.

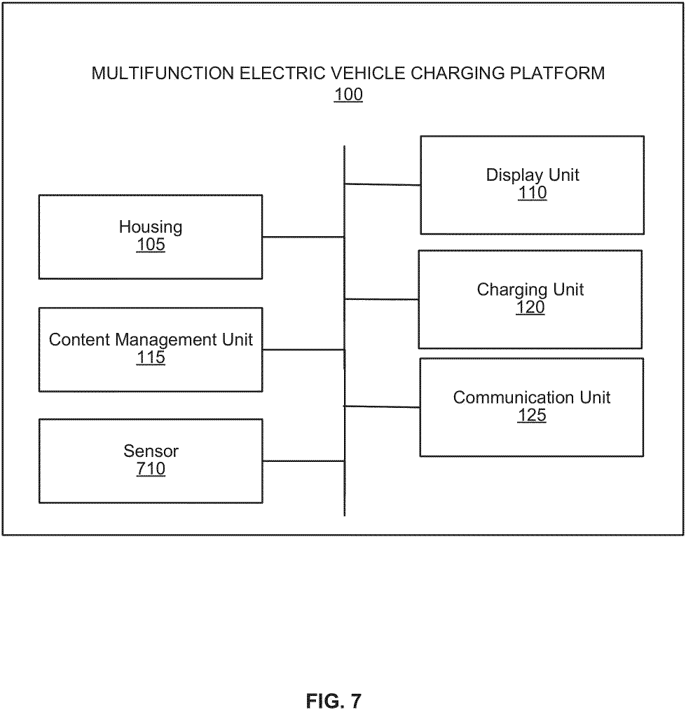

FIG. 7 is a block diagram illustrating components of a multifunction electric vehicle charging platform 100, according to an example embodiment. The platform 100 may include a housing 105, a display unit 110, a content management unit 115, a charging unit 120, a communication unit 125, and a sensor 710 (e.g., a camera). The structure and operations performed by the components of the platform 100 are described with reference to FIGS. 1-6 and 8-18.

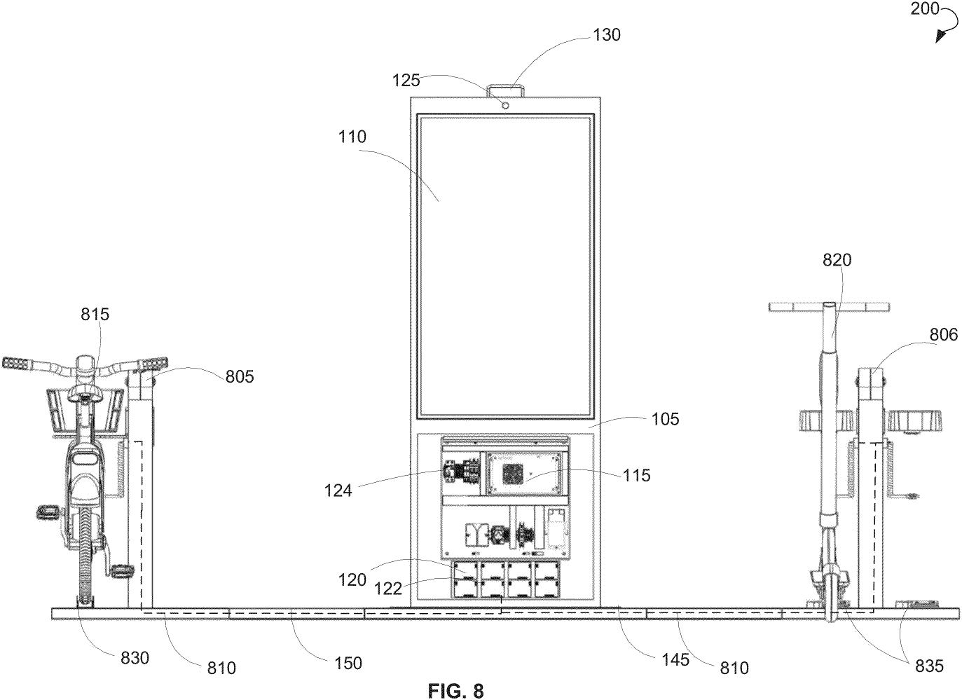

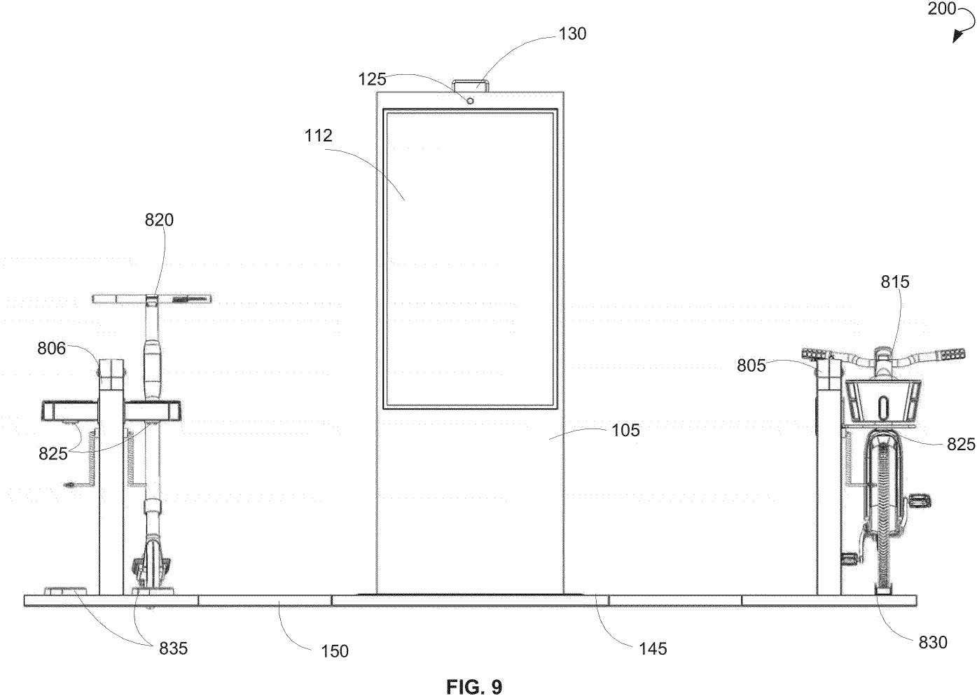

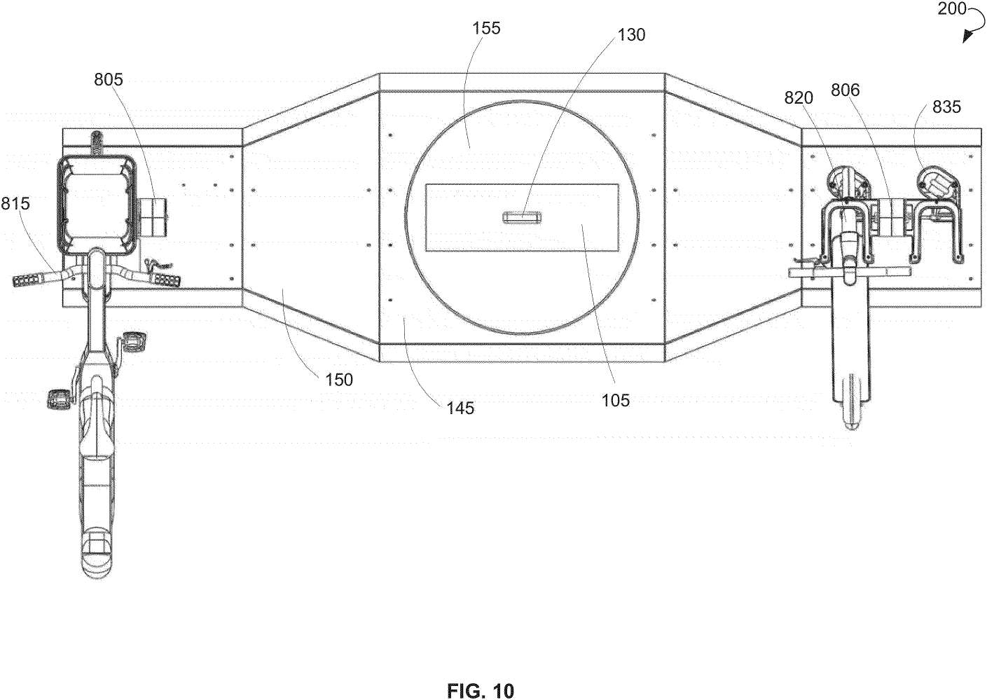

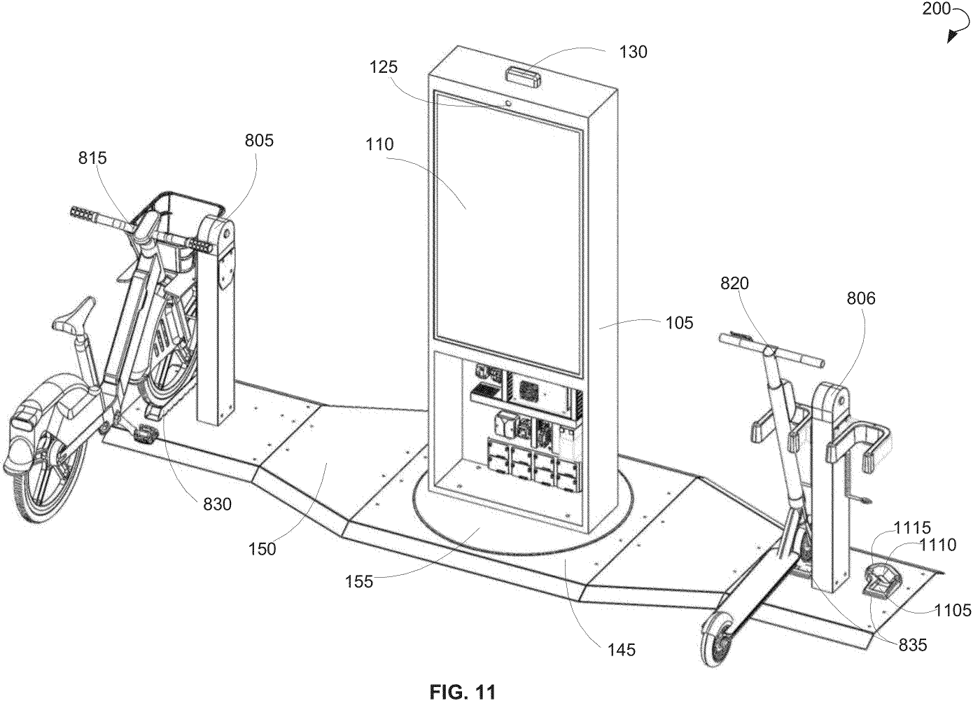

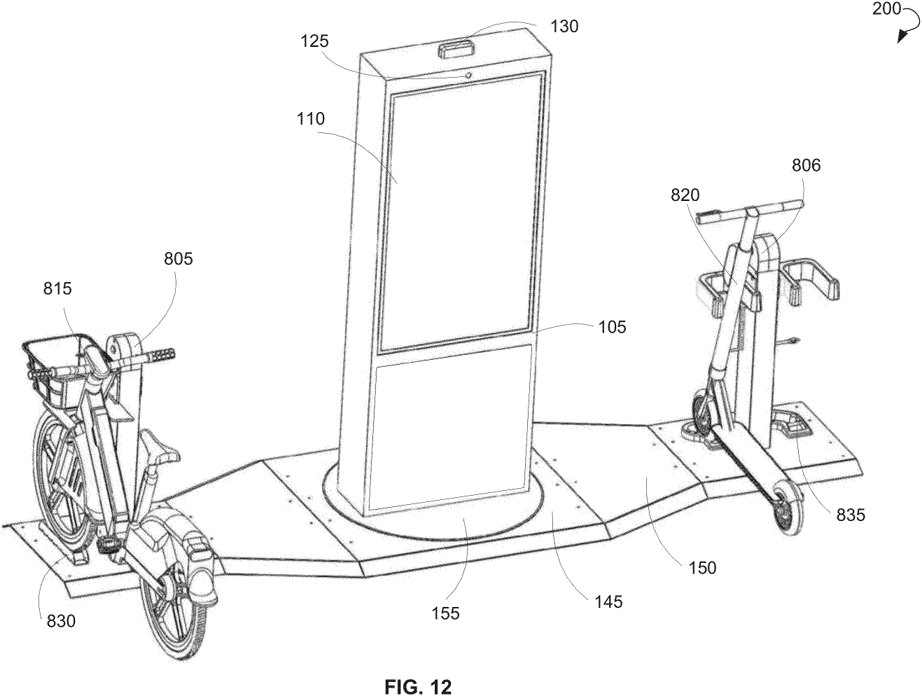

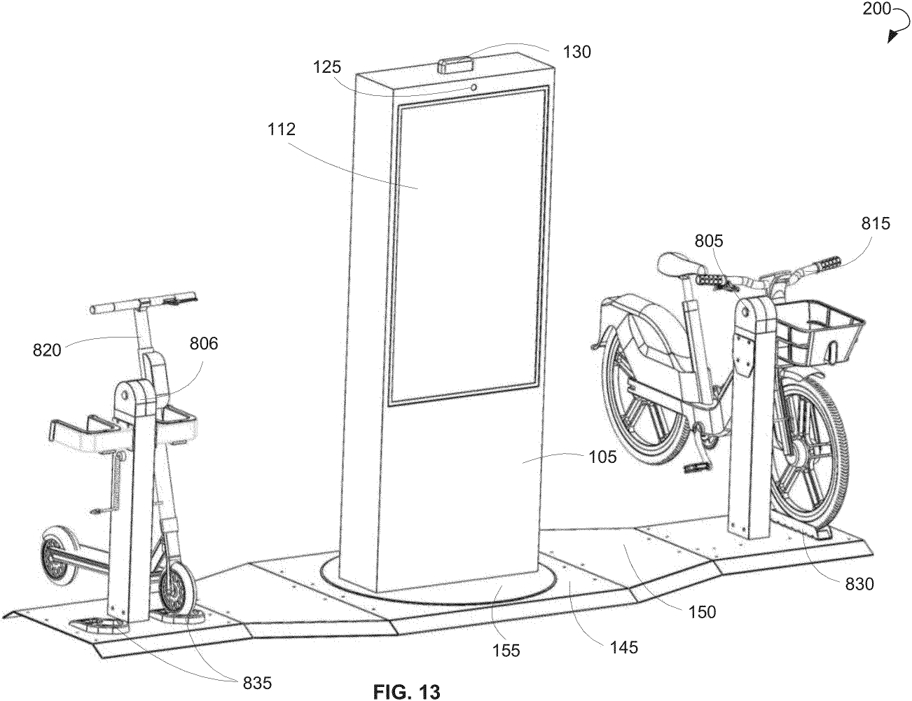

FIGS. 8-13 are views of a multifunction electric vehicle charging platform 200 (also referred to as a platform 200) from various perspectives, according to another example embodiment. Specifically, FIG. 8 is a front view of the platform 200, FIG. 9 is a rear view of the platform 200, FIG. 10 is a top view of the platform 200, FIG. 11 is a front perspective view of the platform 200, FIG. 12 is a front perspective view of the platform 200, and FIG. 13 is a rear perspective view of the platform 200.

The platform 200 may have the same elements as elements of platform 100 shown in FIG. 7. Specifically, the platform 200 may include a housing 105, a display unit 110 and/or 112 placed in the housing 105, a content management unit 115, a charging unit 120, a communication unit 125, and at least one sensor (such as camera 125). The housing 105 may be selected from a self-standing housing, a self-standing rotatable housing, a wall-mounted housing, a hanging housing, and so forth. The display unit 110 may be selected from the following: a digital display, a touch screen display, an electrophoretic display, a LED display, a liquid crystal display, and so forth. The platform 200 may further have vandal proof transparent shields on each of the display units 110 and 112 to protect the display units 110 and 112.

In some embodiments, the display unit 110 or 112 may be placed only on one side of the housing. A blank panel 165 may be placed in place of one display unit on one side of the housing.

In an example embodiment, the platform 100 may include one of the display unit 110, the static advertisement unit 160, and the blank panel 165 on any side of the housing 105. For example, the display unit 110 may be installed on one side of the housing 105 and the blank panel 165 may be installed on the other side of the housing 105. Similarly, the display unit 110 may be installed on one side of the housing 105 and the static advertisement unit 160 may be installed on the other side of the housing 105. Alternatively, two display units 110 may be installed, one on each side of the housing 105.

The communication unit 125 may include one or more of the following: an external antenna for cellular radio connectivity, an external antenna for Wi-Fi radio, internal antenna for Wi-Fi radio, and so forth. The platform 200 may have other near field wireless communication devices (e.g., Bluetooth, Zigbee, etc.).

The platform 200 may further have HDMI or other video cables and a cellular modem gateway. The platform 200 may further have remote controls to access control features of the display units. The platform 200 may further have a wired or wireless keyboard to control components of the platform 200.

The platform 200 may further have a CAN or other interface for communicating with electronics of the LEVs. The platform 200 can attach to and communicate with electronics of the LEV over a standard CAN bus. The communicated information can include requirements, capacity, and current charge state of the battery. The LEV information can be collected upon the initial connection, periodically, or upon request. For example, the information broadcast by the LEV over an interface, such as a CAN interface (also known as a CAN bus), can be collected. Once the LEV is plugged into the platform 200, the information can be communicated to the platform 200, which can, in turn, communicate the information to the backend system via a network. With bidirectional communications, logs can be downloaded from the LEV. If the power structure loses its connectivity with the backend system, it can potentially allow reading the logs made on the LEV side. In an example embodiment, the platform 200 may further have a communications board controlling the communication of the platform 200 with the LEVs.

The platform 200 may further have power distribution cables for distributing power to all electronic components of the LEV. The platform 200 may further have cable trays for accommodating cables. In an example embodiment, the platform 200 may further have cable-free spring loaded charge contacts and cable-free rigid charge contacts.

The content management unit 115 may be configured to control receiving content and displaying the content on the at least one display unit 110 and/or 112. The charging unit 120 may include a charge headboard 122 and a power distribution board 124 installed in the housing 105. The charging unit 120 may further have a charge cable 810.

The platform 200 may further include a plurality of docking and charging bays 805 and 806. The plurality of docking and charging bays 805 and 806 may be provided for docking a LEV such as a LEV 815 (e.g., an electric bicycle) or a LEV 820 (an electric scooter). The plurality of docking and charging bays 805 and 806 may be installed at a predetermined distance from the housing 105. The charge cable 810 may be hung from the housing 105 and have one of its ends placed outside of the housing 105. Specifically, the charge cable 810 may connect the charge headboard 122 of the platform 200 and each of the plurality of docking and charging bays 805 and 806. The charge cable 810 may be configured to supply power from the charging unit 120 disposed in the housing 105 to the LEV 815 and the LEV 820 when the LEV 815 and the LEV 820 are docked in the plurality of docking and charging bays 805 and 806.

In an example embodiment, each of the plurality of docking and charging bays 805 and 805 may include a parking sensor 825. The parking sensor 825 may be configured to provide an indication of a presence of the LEV 815 or 820 in one of the plurality of docking and charging bays 805 and 806 to the backend system. The parking sensor 825 may include one or more of the following: an optical reflection sensor, an optical beam sensor, an ultrasonic signal sensor, a road cell sensor, a magnetic sensor, an infrared reflective sensor, and so forth. The platform 100 may further have a parking sensor controller for controlling an operation of the parking sensor 825 and providing the collected data to the backend system.

In an example embodiment, each of the plurality of docking and charging bays 805 and 806 may include one or more docking bay corrals 830. The docking bay corral 830 may be configured to accommodate a wheel of the LEV when the LEV is parked at the docking and charging bay and align the LEV in the docking and charging bay. The docking bay corral 830 may be configured in a form of a rail with two raised sides. The sides may prevent the movement of the wheel of the LEV to the left and the right when the LEV is parked.

In an example embodiment, each of the plurality of docking and charging bays 805 and 806 may include one or more wheel blocks 835. The wheel block 835 may be configured to align the LEV in the docking and charging bay and limit a movement of the LEV after the LEV is docked with the docking and charging bay. The wheel block 835 may be located in line with a bottom surface of wheels of the LEV and configured to orient the LEV in the docking and charging bays 805 and 806 for optimizing the parking density. The wheel block 835 may be further configured to limit a movement of the LEV after the LEV 815 is docked with the docking and charging bays 805 and 806 (i.e., hold the LEV 815 in place). Optionally, the wheel block 835 may be further configured to limit or set the allowable size of wheel that can fit in the docking and charging bays 805 and 806.

As can be seen in FIG. 11, the wheel block 835 may include a straight part 1105 and a curved part 1110. The curved part 1110 may be turned with respect to the straight part 1105, e.g., turned to the left as shown in FIG. 11.

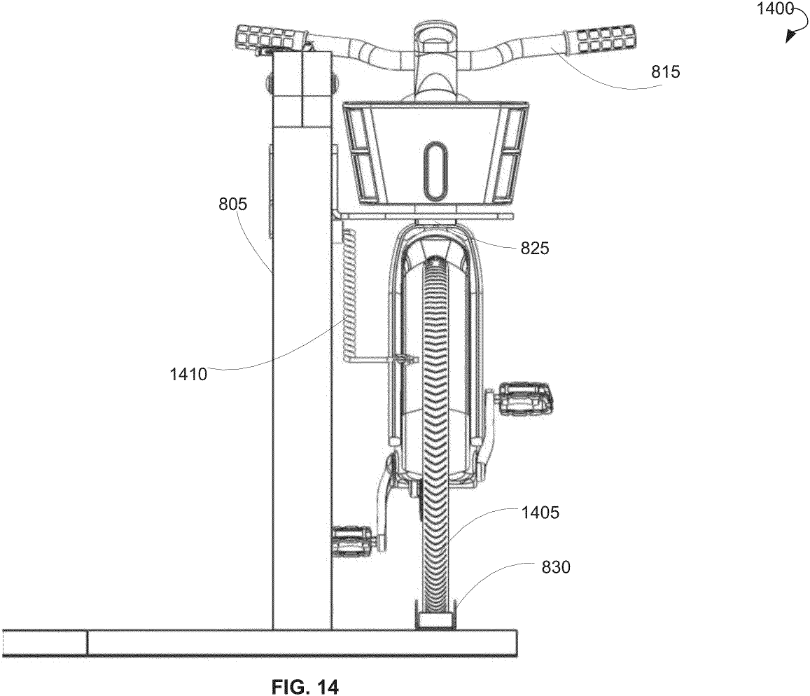

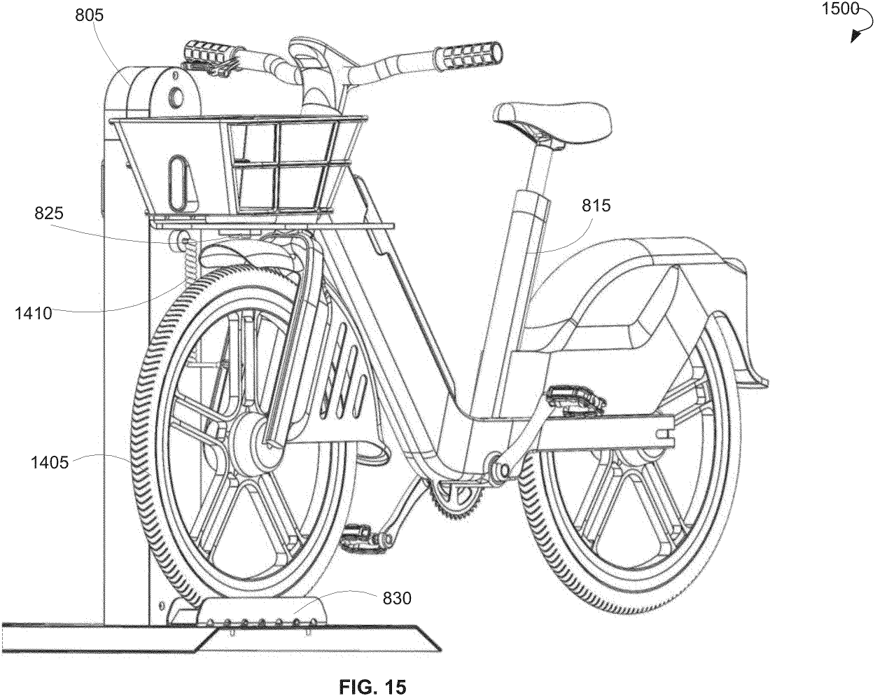

FIG. 14 is a front view 1400 of a docking and charging bay, according to an example embodiment. FIG. 15 is a front perspective view 1500 of the docking and charging bay, according to an example embodiment. The LEV 815 may be docked in the docking and charging bay 805. A front wheel 1405 of the LEV 815 may be accommodated in the docking bay corral 830. The docking and charging bay 805 may have a parking sensor 825. The docking and charging bay 805 may further have a charge cable 1410 for providing power from the platform 100 to a battery of the LEV 815. In an example embodiment, the docking and charging bay 805 may be configured to dock one LEV 815.

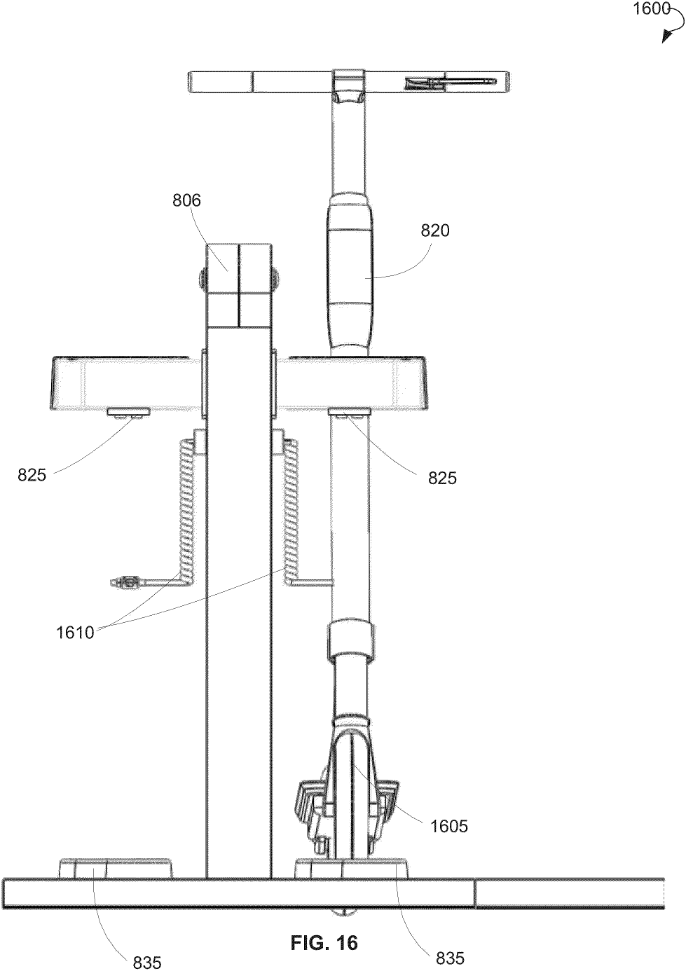

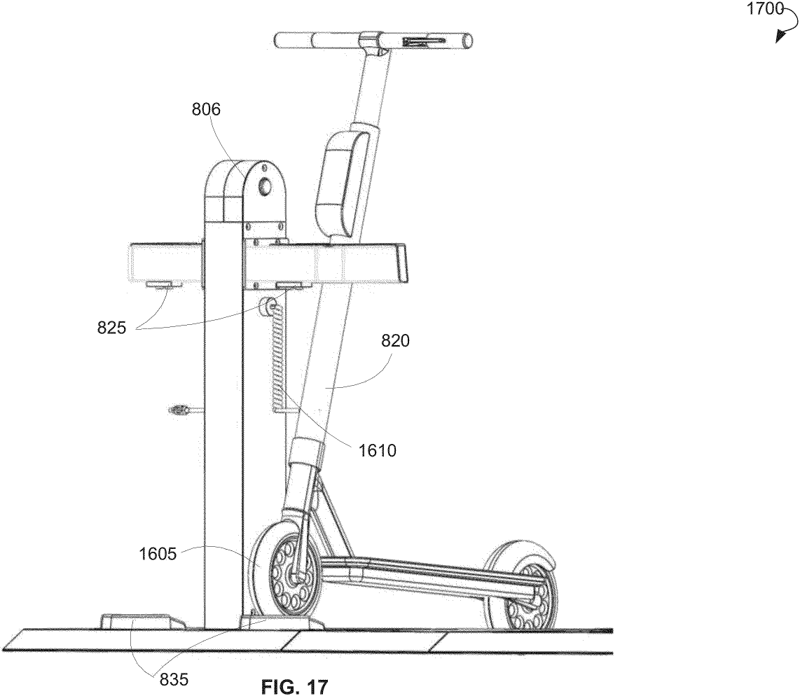

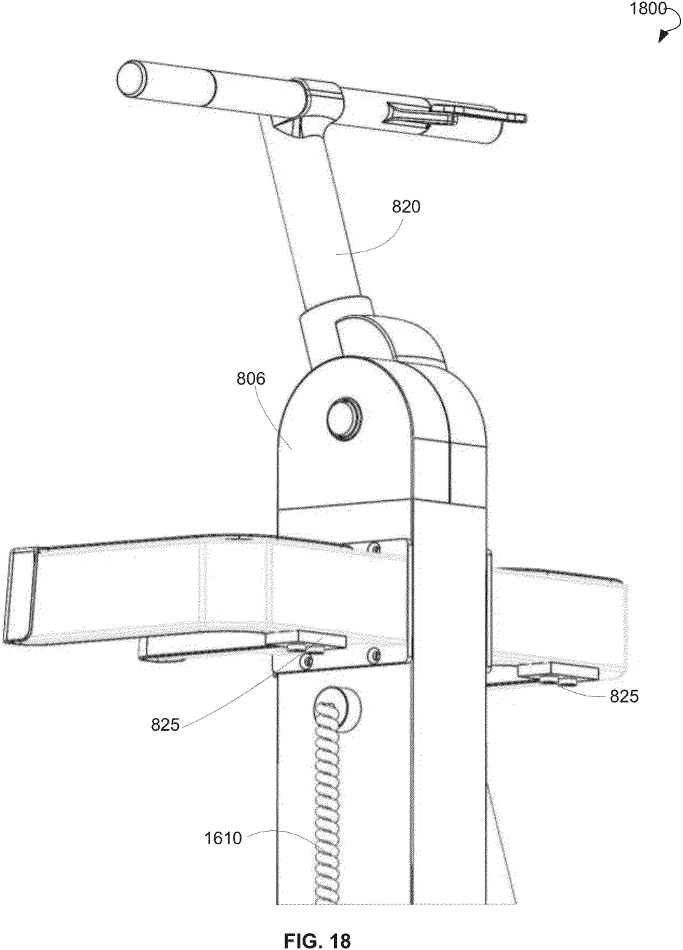

FIG. 16 is a front view 1600 of a docking and charging bay, according to an example embodiment. FIG. 17 is a front perspective view 1700 of the docking and charging bay, according to an example embodiment. FIG. 18 is a portion view of a docking and charging bay, according to an example embodiment. The LEV 820 may be docked in the docking and charging bay 806. A front wheel 1605 of the LEV 820 may be accommodated in the wheel block 835. The docking and charging bay 806 may be configured to dock two LEVs 820. The docking and charging bay 806 may have two parking sensors 825, one on each side of the docking and charging bay 806. The docking and charging bay 806 may further have a charge cable 1610 for providing power from the platform 200 to a battery of the LEV 820.

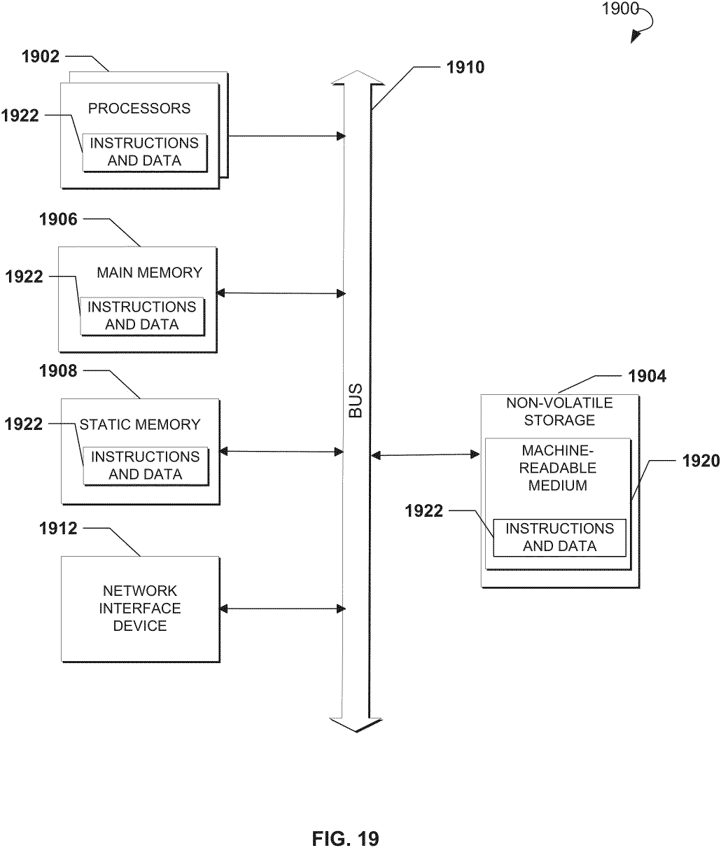

FIG. 19 shows a diagrammatic representation of a computing device for a machine in the exemplary electronic form of a computer system 1900, within which a set of instructions for causing the machine to perform any one or more of the methodologies discussed herein can be executed. In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a field programmable gate array, a personal computer (PC), a tablet PC, a set-top box, a cellular telephone, a digital camera, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1900 may include a processor or multiple processors 1902, a non-volatile storage 1904, a main memory 1906, and a static memory 1908, which communicate with each other via a bus 1910. The computer system 1900 may also include a network interface device 1912. The non-volatile storage 1904 may include a computer-readable medium 1920, which stores one or more sets of instructions and data 1922 embodying or utilized by any one or more of the methodologies or functions described herein. The instructions and data 1922 can also reside, completely or at least partially, within the main memory 1906 and/or within the processors 1902 during execution thereof by the computer system 1900. The main memory 1906 and the processors 1902 also constitute machine-readable media.

While the computer-readable medium 1920 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, Random Access Memory, Read-Only Memory, and the like.

The example embodiments described herein may be implemented in an operating environment comprising software installed on a computer, in hardware, or in a combination of software and hardware.

Thus, multifunction electric vehicle charging platforms have been described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

What is claimed is:

1. A multifunction electric vehicle charging platform, the platform comprising:
a housing;
at least one display unit placed in the housing;
a content management unit configured to control receiving content and displaying the content on the at least one display unit;
a charging unit configured to be connected to at least one light electric vehicle (LEV) and to provide power to the at least one LEV;
at least one sensor attached to the housing and configured to collect data associated with the at least one LEV; and
a communication unit configured to communicate with a backend system.

2. The platform of claim 1, wherein the at least one sensor includes a camera, wherein the data collected by the at least one sensor includes one or more of the following: a number of people walking in a proximity of the platform, demographics associated with the people in the proximity of the platform, a face of a person, a gender of a person, and an age of a person.

3. The platform of claim 1, further comprising:
a baseplate; and
a rotatable disk placed on the baseplate, the housing being installed on the rotatable disk.

4. The platform of claim 1, further comprising a parking sensor, the parking sensor being configured to detect one or more of the following: presence of the at least one LEV connected to the charging unit, a total number of available bays, a total number of occupied bays for docking, and a total number of occupied bays for docking and charging.

5. The platform of claim 1, wherein the charging unit includes a charge headboard and a power distribution board, the charge headboard and the power distribution board being installed in the housing.

6. The platform of claim 1, wherein the charging unit includes a charge head board, a power distribution board, and a charge cable, the charge headboard and the power distribution board being installed in the housing.

7. The platform of claim 6, further comprising a plurality of docking and charging bays installed at a predetermined distance from the housing, wherein the charge cable is configured to connect the charge headboard and each of the plurality of docking and charging bays, the charge cable being configured to supply power from the charging unit to the at least one LEV when the at least one LEV is docked in one of the plurality of docking and charging bays.

8. The platform of claim 1, wherein the content includes one or more of the following: an advertisement, transportation station transit information, a notification, a public service announcement, a warning, a transport schedule, and a number of available docking and charging bays.

9. The platform of claim 1, wherein the content is received from the backend system.

10. The platform of claim 1, wherein the housing has a shape of a rectangular parallelepiped having a first side and a second side opposite to the first side, wherein a first display unit of the at least one display unit is placed on the first side; and
wherein a second display unit of the at least one display unit is placed on the second side, the first display unit and the second display unit facing opposite directions.

11. The platform of claim 1, wherein the charging unit is configured to connect to one or more power sources, the one or more power sources being selected from an electric grid, a solar power source, a self-generating power source, and a battery storage.

12. The platform of claim 1, wherein the content management unit is configured to change the content displayed on the at least one display unit in real time, wherein the content to be displayed is selected based on the data associated with the at least one LEV.

13. The platform of claim 1, wherein the charging unit is configured to read one or more parameters associated with the at least one LEV, the one or more parameters being selected from a group comprising a charge level of the at least one LEV, a charge state of the at least one LEV, a rate of charge, a voltage, a current, a type of the battery, and a time.

14. A multifunction electric vehicle charging platform, the platform comprising:
a housing;
at least one display unit placed in the housing;
a content management unit configured to control receiving content and displaying the content on the at least one display unit;
a charging unit comprising a charge head board, a power distribution board, and a charge cable, the charge headboard and the power distribution board being installed in the housing;
at least one sensor attached to the housing and configured to collect data associated with an at least one light electric vehicle (LEV);
a communication unit configured to communicate with a backend system; and
a plurality of docking and charging bays for docking the at least one LEV, the plurality of docking and charging bays being installed at a predetermined distance from the housing, wherein the charge cable connects the charge headboard and each of the plurality of docking and charging bays, the charge cable being configured to supply power from the charging unit to the at least one LEV when the at least one LEV is docked in one of the plurality of docking and charging bays.

15. The platform of claim 14, wherein the plurality of docking and charging bays include a parking sensor configured to provide an indication of a presence of the at least one LEV in one of the plurality of docking and charging bays to a backend system, wherein the parking sensor includes one or more of the following: an optical reflection sensor, an optical beam sensor, an ultrasonic signal sensor, a road cell sensor, a magnetic sensor, and an infrared reflective sensor.

16. The platform of claim 14, wherein the data associated with the at least one LEV include one or more of the following: charge information, battery requirements, a battery state, pre-use settings, an identifier (ID) of the at least one LEV, a state of the battery, temperature of the battery, vehicle circulation, and infrastructure utilization.

17. The platform of claim 14, wherein the housing is selected from: a self-standing housing, a self-standing rotatable housing, a wall-mounted housing, and a hanging housing.

18. The platform of claim 14, wherein the at least one display unit is selected from the following: a digital display, a touch screen display, an electrophoretic display, a Light-emitting diode display, and a liquid crystal display.

19. The platform of claim 14, wherein the communication unit includes one or more of the following: an external antenna for cellular radio connectivity, an external antenna for Wi-Fi radio, and an internal antenna for Wi-Fi radio.

20. A multifunction electric vehicle charging platform, the platform comprising:
a housing having a shape of a rectangular parallelepiped having a first side and a second side opposite to the first side;
at least one display unit placed in the housing, wherein a first display unit of the at least one display unit is placed on the first side; and
wherein a second display unit of the at least one display unit is placed on the second side, the first display unit and the second display unit facing opposite directions;
a content management unit configured to control receiving content and displaying the content on the at least one display unit;
a charging unit comprising a charge head board, a power distribution board, and a charge cable, the charge headboard and the power distribution board being installed in the housing;
at least one sensor attached to the housing and configured to collect data associated with at least one LEV;
a communication unit configured to communicate with a backend system; and
a plurality of docking and charging bays for docking the at least one LEV, the plurality of docking and charging bays being installed at a predetermined distance from the housing, wherein the charge cable is configured to connect the charge headboard and each of the plurality of docking and charging bays, the charge cable being configured to supply power from the charging unit to the at least one LEV when the at least one LEV is docked in one of the plurality of docking and charging bays,
wherein the plurality of docking and charging bays include a parking sensor configured to provide an indication of a presence of the at least one LEV in one of the plurality of docking and charging bays to a backend system.
